(19) United States
(12) Patent Application Publication
(10) Pub. No.: US 2009/0308269 A1
(43) Pub. Date: Dec. 17, 2009

(54) Spray dampening valves with associated drive signals in an offset printing process

(76) Inventors: Michael A. Niemiro, Plainfield, IL (US); Corey Hill, Chicago, IL (US)

Correspondence Address: Carmen Patti Law Group , LLC, ONE N. LASALLE STREET, 44TH FLOOR, CHICAGO, IL, 60602, US

(21) Appl. No.: 12/157,528

(22) Filed: Jun. 11, 2008

(51) Int. Cl. B41L 23/08

(52) U.S. Cl. 101/147

(57) ABSTRACT

An embodiment of the present method and apparatus may have: a printing unit having a plurality of spraybar assemblies; each of the spraybar assemblies having a respective plurality of spray valves; a controller that outputs respective predetermined control signals of a plurality of control signals for the plurality of spray valves in each of the spraybar assembly; and each control signal of the plurality of control signals having a series of positive and negative pulses; wherein residual magnetism is substantially minimized in the spray valves by the occurrence of positive and negative pulses.

### TECHNICAL FIELD

The invention relates generally to dampening spray systems in offset printing processes and, more specifically, to formation and supply of drive signals to spray dampening valves in the dampening spray systems.

### BACKGROUND

In the offset printing process, a small amount of a dampening solution, i.e., water with certain additives, is supplied to the offset plate, which then comes in contact with the inking rollers, the ink adhering to the image on the plate and the dampening solution adhering to the other portions of the plate. The quantity and placement of the dampening solution must be varied for different types and densities of ink, variations in printing densities and ink coverage, and press speed. Control of the application of the dampening fluid is particularly important in four-color process, where variations will affect color. If too little fluid is applied, printing will occur in areas where none is desired. If too much fluid is applied, printing may not occur in some areas, or image density may drop.

Various systems for dampening the plate cylinder of an offset printing apparatus are in use today. One such system employs dampening rollers, which rotate partially within an open trough containing dampening fluid. The dampening rollers bear directly or indirectly against the plate cylinder, thereby supplying a film of dampening fluid to the plate cylinder. This system, however, suffers from a number of inherent disadvantages from the standpoint of both operation and maintenance. From the operational standpoint, the system is too imprecise and difficult to control. Frequently, too much or too little solution is applied to the plate roller, or at least to certain areas of the plate roller, reducing the printing quality.

Another known dampening system eliminates the open fluid container and the immersed dampening roll, and replaces them with a closed system which pumps dampening fluid as a spray onto a dampening roll train for application to the plate cylinder. In such a spray dampening system, the dampening fluid is sprayed onto the press rollers by means of a linear array of spray nozzles with the spray patterns of the individual nozzles merging to form a continuous composite spray pattern across the surface of the press roller. It is important in obtaining proper dampening that the distribution of dampening fluid be as uniform as possible. There should be no starved areas where the amount of dampening fluid is substantially less than the other areas on the surface of the roller, and the overlapping of the adjacent individual spray patterns should be minimized so that there is little or no excessive dampening fluid applied to any portion of the dampening roller.

Various attempts have been made at adjusting the amount of dampening fluid applied to the dampening roll. In known dampening systems nozzles fluctuate between open and closed positions to regulate the amount of dampening fluid applied to the rolls, nozzles are pulsed on and off with the pulse width and/or frequency being adjusted, and dampening fluid is delivered through alternate laterally adjacent nozzles, etc.

In this context it has been shown that it is basically more cost-effective to administer the dampening agent in short bursts of low volumes than to supply larger volumes of dampening agent in one go. In practice, however, the options for shortening the opening times of conventionally marketed valves are limited, each nozzle having an associated valve. Even valve elements with very small masses cannot be moved speedily or precisely enough to reduce the opening and closing times to under 10 or even 5 milliseconds. With cycle times that short, the valve elements are unable to move into their full opening and closing positions.

In general valves are preferably solenoid or servo type valves each including a reciprocal plunger or other valve flow controller moveable by its valve drive element. As is well known in the art, when the plunger reciprocates up under the direction of the valve drive element, pressurized dampening fluid present in the supply line passes under the valve plunger and out the nozzle. Conversely, when the plunger is shifted downward by the valve drive element, the plunger interrupts the flow of dampening fluid from the supply line. The valve drive elements are preferably solenoid type operators but may also be voice coil, piezo, polymer activated, or servo type drive elements.

When the solenoid type operators are used, residual magnetism develops over time and can degrade operation of the valves. When the valves are unipolar the same magnetic field is generated. For example, if the coil always generates the same magnetic field polarity for the pole pieces, over time each piece will take on some degree of residual magnetism.

The energy required to actuate the valve diminishes due to the residual magnetism. The state of the residual magnetism is unknown and cannot be predicted. Thus the characteristics of the valve change over time in a non-predictable manner. Appropriate compensation is not practical. For example, a control algorithm cannot be constructed that will accurately predict this behavior.

The residual magnetism can be affected by other parameters, such as, external shock forces.

### SUMMARY

One embodiment of the present method and apparatus encompasses an apparatus. In this embodiment the apparatus may comprise: a printing unit having a plurality of spraybar assemblies; each of the spraybar assemblies having a respective plurality of spray valves; a controller that outputs respective predetermined control signals of a plurality of control signals for the plurality of spray valves in each of the spraybar assembly; and each control signal of the plurality of control signals having a series of positive and negative pulses; wherein residual magnetism is substantially minimized in the spray valves by the occurrence of positive and negative pulses.

Another embodiment of the present method and apparatus encompasses a method. This embodiment of the method may comprise: providing at least one spraybar assembly in a printing unit, the spraybar assembly having a plurality of spray valves; outputting respective predetermined control signals of a plurality of control signals for the plurality of spray valves in the at least one spraybar assembly; and forming each control signal of the plurality of control signals with a series of positive and negative pulses that substantially minimizes residual magnetism in the spray valves by the occurrence of positive and negative pulses.

### DESCRIPTION OF THE DRAWINGS

Features of the embodiments will become apparent from the description, the claims, and the accompanying drawings in which:

FIG. 1 is a schematic drawing of a spray dampening system that incorporates the present method and apparatus;

FIG. 2 is one embodiment of a spraybar assembly for use in the FIG. 1 spray dampening system;

FIG. 3 depicts a known circuit arrangement for supplying drive signals to a spraybar assembly;

FIG. 4 depicts a typical waveform that is applied as a control signal to each of the valve coils;

FIG. 5 depicts a waveform for a control signal for the valves according to the present method and apparatus;

FIG. 6 depicts one embodiment of a control system for controlling the valves in a spraybar assembly according to the present method and apparatus;

FIG. 7 depicts an alternative embodiment of the present method and apparatus;

FIG. 8 is a flow diagram of a method according to the present method;

FIG. 9 depicts a hysteresis loop;

FIG. 10 depicts a waveform according to the present method and apparatus for operation of a valve;

FIG. 11 depicts an alternative embodiment for a control system wherein a coil of a valve is tied to ground at one end; and

FIG. 12 depicts an alternative embodiment for a control system of a valve with two coils.

### DETAILED DESCRIPTION

In the offset printing process, a small amount of a dampening solution, for example water with certain additives, is sprayed onto the offset plate by a plurality of solenoid valves.

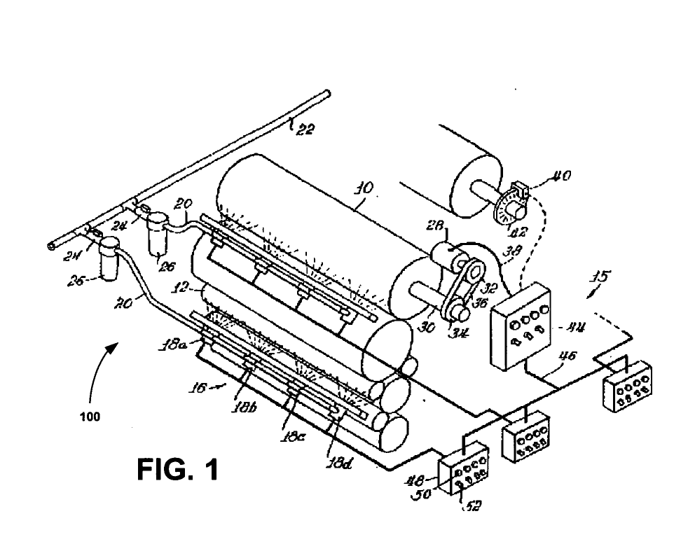

FIG. 1 is a schematic drawing of a spray dampening system 100 that may incorporate the present method and apparatus. There is shown a typical printing operation including various rollers such as a plate cylinder 10, and an inking roller 12 both rollers of which require the application of a dampening fluid to the surfaces thereof for the proper transfer of the photoengraved image on the plate cylinder 10 to the paper (not shown).

While different printing operations may require fewer or more rollers than shown in FIG. 1, it is sufficient to realize that irrespective of the particular printing operation the application of spray dampening solution to roller surfaces is required to effect a proper transfer of ink from the offset plate cylinder to the paper medium.

The spray dampening control system, generally designated 15, includes one or more solenoid-operated spray nozzle bars, one shown as reference character 16. In the printing operation, spray bar 16 may include, for example, four solenoid-operated spray nozzles 18a, 18b, 18c, 18d, spaced apart from each other and from the inking roller 12, such that the spray jet emitted from the nozzles uniformly covers the surface of such roller. For the sake of clarity the inking system for applying the oil base ink to the inking roller 12 is not shown. Herein the solenoid-operated spray nozzle is also referred to in general as a valve.

Each solenoid controlled spray nozzle may have an input plumbed to a liquid supply line 20. The electrically controlled nozzles 18a, 18b, 18c, 18d may be, for example, of a normally off type where the application of an electrical signal opens the nozzle valve to allow the pressurized liquid, damping fluid, to be sprayed for the duration of the signal. Ideally electrically controlled nozzles of this type, being either fully on or off, provide a constant angle of spray when activated and thus maintain a constant area of coverage even though the volume of liquid sprayed may be reduced. With this arrangement the volume of liquid sprayed is increased either with an increase in frequency, or by an increase in the duration of the electrical signal. A main liquid supply conduit 22 provides dampening fluid at a pressure, for example, of about 40-90 pounds to the supply lines 20 through respective shut off valves 24 and filters 26.

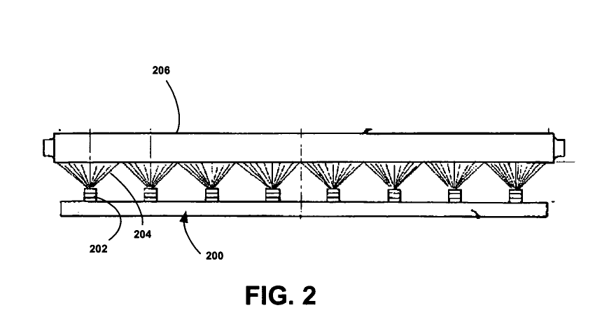

FIG. 2 is one embodiment of a spraybar assembly 200 for use in the FIG. 1 spray dampening system. The spraybar assembly 200 may have a variety of different forms and configurations. A solenoid-operated spray nozzle 202 is shown spraying dampening fluid 204 onto roller 206.

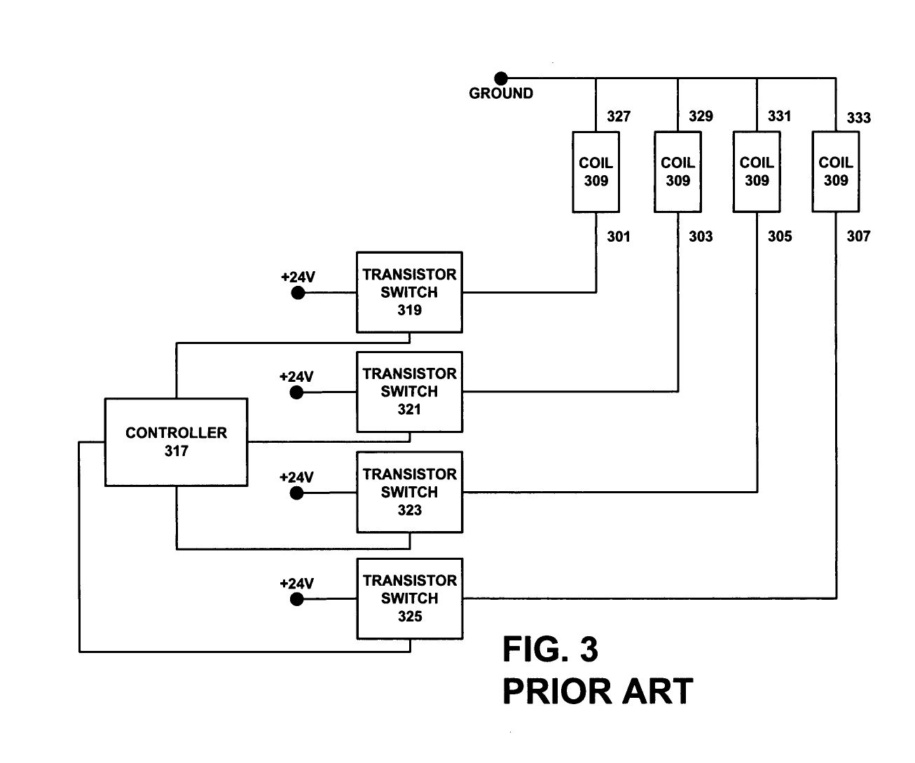

FIG. 3 depicts a known circuit arrangement for supplying drive signals to a spraybar assembly. Numerous drive systems are known that supply drive signals to the valves in the spraybar assembly. Typically, as depicted in FIG. 3 one lead 301, 303, 305, 307 of a respective coil 309, 311, 313, 315 of each valve is connected to a control system 317 via a respective transistor 319, 321, 323, 325. The other leads 327, 329, 331, 333 are each connected to ground. Alternatively, the other leads 327, 329, 331, 333 may be connected to a voltage source, such as +24 volts. As each respective transistor 319, 321, 323, 325 closes intermittently, current flows in the coil 309, 311, 313, 315 of a respective valve and generates a magnetic field, drawing a plunger up of the valve. When the respective transistor 319, 321, 323, 325 is turned off, the magnetic field is released. Typically, a spring mechanically returns the plunger to its rest position.

Typically, there is an array of 4, 6, 8, etc valves. The common lead going out to each of the valves may have its own unique return lead. The leads may be on printed circuit boards, specific wiring, or any other means of carrying electrical current and signals.

When the valves are unipolar the same magnetic field is generated. As described above, if the coil always generates the same magnetic field polarity for the pole pieces, over time each of the components will take on some degree of residual magnetism.

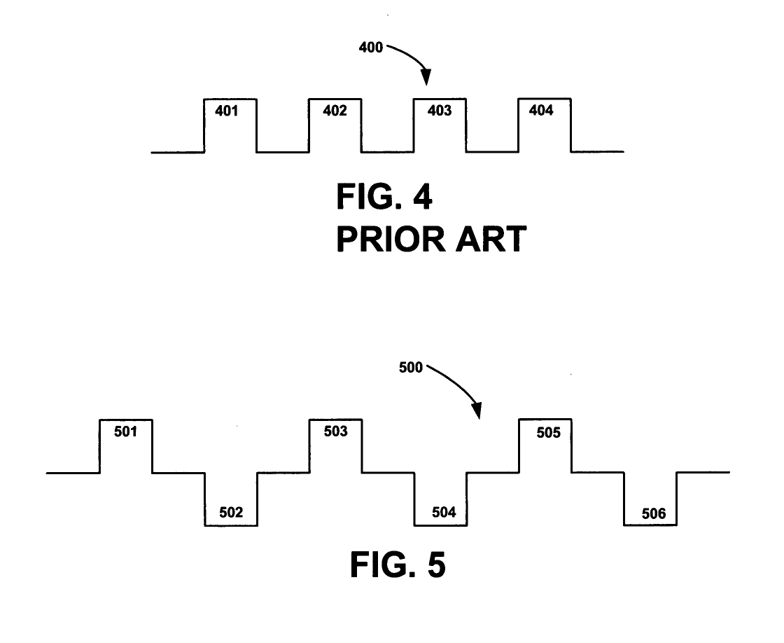

FIG. 4 depicts a typical waveform 400 that is applied as a control signal to each of the valve coils 309, 311, 313, 315. In this example the control signal 400 has a series of positive going pulses 401, 402, 403, 404. The magnitude, duration, and frequency of the pulses may be set as a function of the requirements of the spraybar assembly.

FIG. 5 depicts a waveform for a control signal for the valves according to the present method and apparatus. In this embodiment of the present method and apparatus a control signal 500 is formed of a series of positive pulses 501,503,505 interleaved with a series of negative pulses 502, 504, 506. Applying such pulses negates a build up of residual magnetism. The control signal 500 may be used with unipolar and bipolar valves in order to have both positive and negative pulses operating the valves. In a printing unit there may be a plurality of control signals. In some embodiments it is envisioned that at least one of the control signals may be different in terms of at least one of pulse shape, pulse duration, and pulse frequency from other control signals.

In one embodiment each control signal of the plurality of control signals may have a series of positive pulses interleaved with a series of negative pulses. Each negative pulse may be a mirror image of each positive pulse. In another embodiment each control signal of the plurality of control signals may have at least one positive pulse followed by at least one negative pulse. For example, two positive pulses may be followed by two negative pulses, etc., or two positive pulses may be followed by one negative pulse followed by one positive pulse, and followed by two negative pulses, etc. Thus, the control signal may be formed of groups of positive pulses that alternate with groups of negative pulses. The combination of positive and negative pulses combine to substantially cancel out the residual magnetism of an associated valve such that residual magnetism is substantially eliminated in the valves.

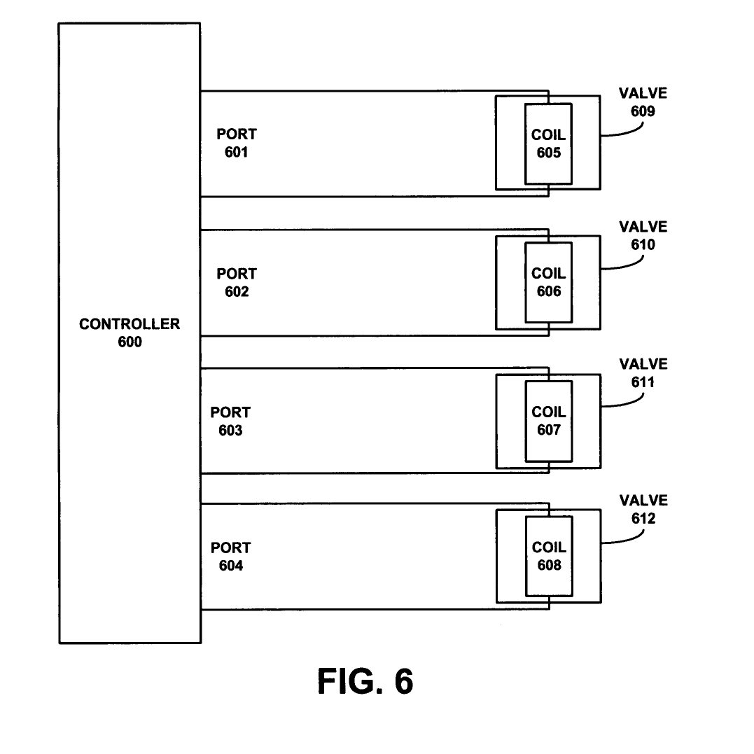

FIG. 6 depicts one embodiment of a control system for controlling the valves in a spraybar assembly according to the present method and apparatus. In this embodiment the controller 600 has a plurality of ports 61, 602, 603, 604 that are respectively connected to coils 605, 606, 607, 608 of valves 609, 610, 611, 612. Each of the valves 609, 610, 611, 612 opens and closes to spray damping fluid in response to each of the positive and negative pulses. However, there is no build up of residual magnetism due to the alternating positive and negative pulses. Thus, the long-term operation of the system is improved over the prior art systems.

In the system depicted in FIG. 6, each of the devices, which in an offset printing system are valves with nozzles that effect a spraying of damping fluid, has a discrete current/control signal loop. Therefore, there is no common. The current may travel in one direction for the device to open, and in the opposite direction for the device to close. These devices are bipolar. Thus for example, for a four-valve system there are eight conductors.

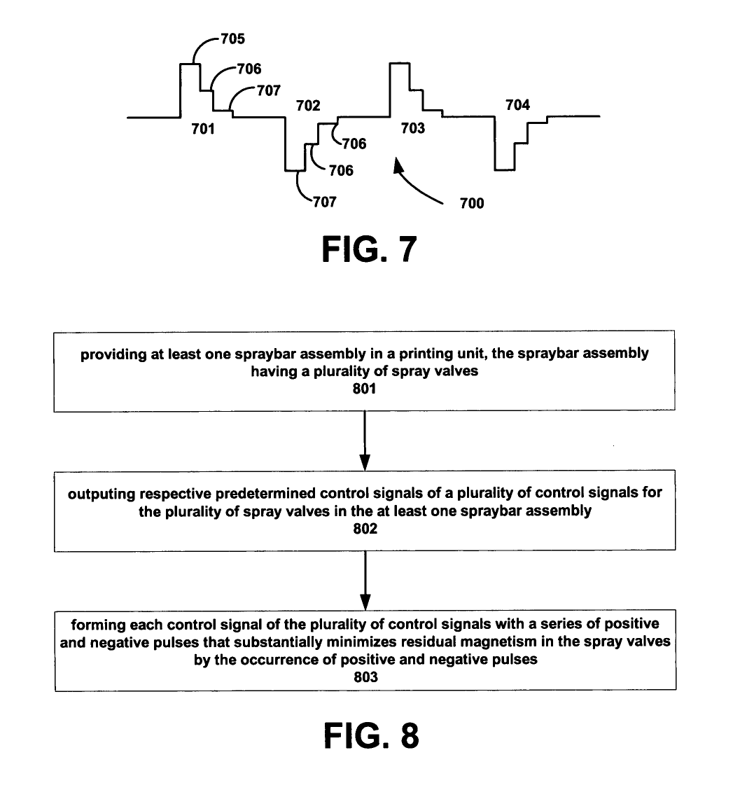

FIG. 7 depicts an alternative embodiment of the present method and apparatus. In this embodiment the control signal 700 is formed of a series of positive pulses 701,703 interleaved with a series of negative pulses 702, 704. Each of the pulses 701, 702, 703, 704 may have a plurality of steps, such as 705, 706, 707 of different voltage or current levels. For a positive going pulse, the peak level 705 may be used to initially open the respective valve, the middle level 706 may be used to stabilize the valve in the open position, and the lower level 707 may be used to hold the valve in the open position. Since the valve may be a bipolar or omnipolar, indifferent of polarity, valve, for a negative going pulse, the peak level 708 may be used to initially open the respective valve, the middle level 709 may be used to stabilize the valve in the open position, and the lower level 710 may be used to hold the valve in the open position.

FIG. 8 is a flow diagram of one embodiment a method according to the present method. This embodiment may have the steps of: providing at least one spraybar assembly in a printing unit, the spraybar assembly having a plurality of spray valves (801); outputting respective predetermined control signals of a plurality of control signals for the plurality of spray valves in the at least one spraybar assembly (802); and forming each control signal of the plurality of control signals with a series of positive and negative pulses that substantially minimizes residual magnetism in the spray valves by the occurrence of positive and negative pulses (803).

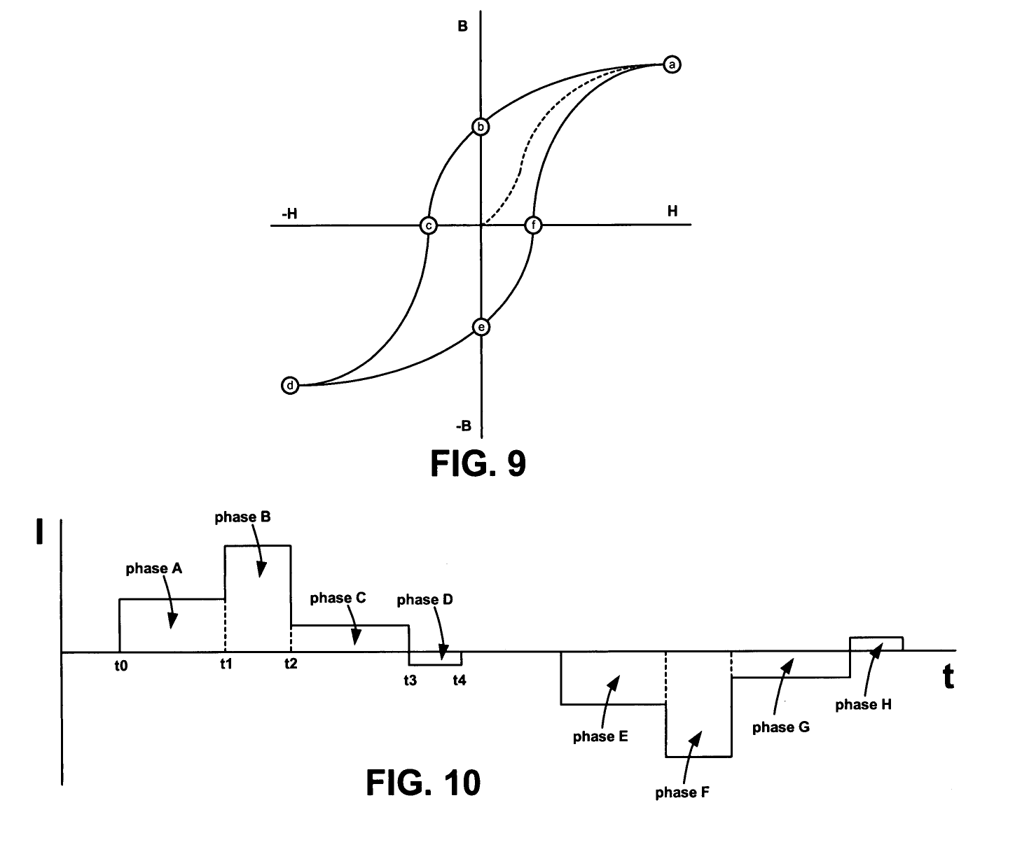

FIG. 9 depicts a hysteresis loop. A hysteresis loop shows the relationship between the induced magnetic flux density (B) and the magnetizing force (H). It is often referred to as the B-H loop. For a ferromagnetic material for example, measuring the magnetic flux of the ferromagnetic material while the magnetizing force is changed generates the loop. A ferromagnetic material that has never been previously magnetized or has been thoroughly demagnetized will follow the dashed line as H is increased. As the line demonstrates, the greater the amount of current applied (H+), the stronger the magnetic field in the component (B+). At point “a” almost all of the magnetic domains are aligned and an additional increase in the magnetizing force will produce very little increase in magnetic flux. The material has reached the point of magnetic saturation. When H is reduced to zero, the curve will move from point “a” to point “b.” At this point, it can be seen that some magnetic flux remains in the material even though the magnetizing force is zero. This is referred to as the point of retentivity on the graph and indicates the remanence or level of residual magnetism in the material. (Some of the magnetic domains remain aligned but some have lost their alignment.) As the magnetizing force is reversed, the curve moves to point “c”, where the flux has been reduced to zero. This is called the point of coercivity on the curve. (The reversed magnetizing force has flipped enough of the domains so that the net flux within the material is zero.) The force required to remove the residual magnetism from the material is called the coercive force or coercivity of the material. As the magnetizing force is increased in the negative direction, the material will again become magnetically saturated but in the opposite direction (point “d”). Reducing H to zero brings the curve to point “e.” It will have a level of residual magnetism equal to that achieved in the other direction. Increasing H back in the positive direction will return B to zero. The curve did not return to the origin of the graph because some force is required to remove the residual magnetism. The curve will take a different path from point “f” back to the saturation point where it completes the loop.

Operation of the valves in the present embodiments also exhibits the hysteresis loop. FIG. 10 depicts a current waveform according to the present method and apparatus for operation of a valve. The waveform in the depicted embodiment consists of a series of pulses N, N+1, N+2, . . . wherein the pulses alternated with their mirror images.

The following are the stages of pulse N.

1. The device will begin at to at the origin of the B-H curve.

2. Phase A is applied to magnetically pre-charge the valve. The magnitude of phase A current is not enough to open the valve. However, it moves toward “a” on the B-H curve.

3. Beginning at t1 and during phase B, full current is applied, the valve opens, and moves to “a” on the B-H curve.

4. Beginning at t2 and during phase C, the valve is held open at lower current. The valve moves toward “b” on the B-H curve.

5. Beginning at t3 and during phase D, the intent is to close the valve. The current is reversed in order to dissipate the magnetic field created by phases A, B and C. Also, this will partially negate some of residual magnetism established by phases A, B and C. The valve moves past “b” on the B-H curve and stops somewhere between “b” and “c”. If phase D did not exist, the valve would stop at “b”. The full cycle ends at t4, in anticipation of the next cycle.

The following are the stages of Pulse N+1.

6. Phase E is equal but opposite to phase A. It is assumed to be greater than any residual magnetism. It moves the valve state past “c” and toward “d” on the B-H curve. It is not enough to open the valve.

7. Phase F opens the valve and moves it to “d” on the B-H curve.

8. Phase G moves the valve between “d” and “e” on the B-H curve.

9. Phase H leaves the valve between “e” and “f” on the B-H curve (absence of phase H would leave the valve at “e”).

For a next Pulse N+2 (not shown), a first phase will move the valve past “f”, and leave it somewhere between “f” and “a”. Each pulse will move the valve state across the H axis, negating residual magnetism with every pulse. If the precharge phases A and B are not present, residual magnetism would have to be overcome when trying to move the valve, which will generate error. The precharge in the alternating format negates the residual magnetism before the “motion” phase (B and F) is delivered.

Furthermore, the control signal may be a voltage waveform rather than a current waveform. In this embodiment a bipolar driver may be used as a current controller, which is programmable. This allows for having a peak current, a middle current, and a lesser current. The peak current opens, the middle current stabilizes, and the lesser current holds until time to release.

It is to be understood that various other waveshapes, some of which can be very complex, may be used according to the present method and apparatus. For example, the drive signal may be a voltage square wave, a current square wave, and a multi-step, multiphase voltage or current waveform.

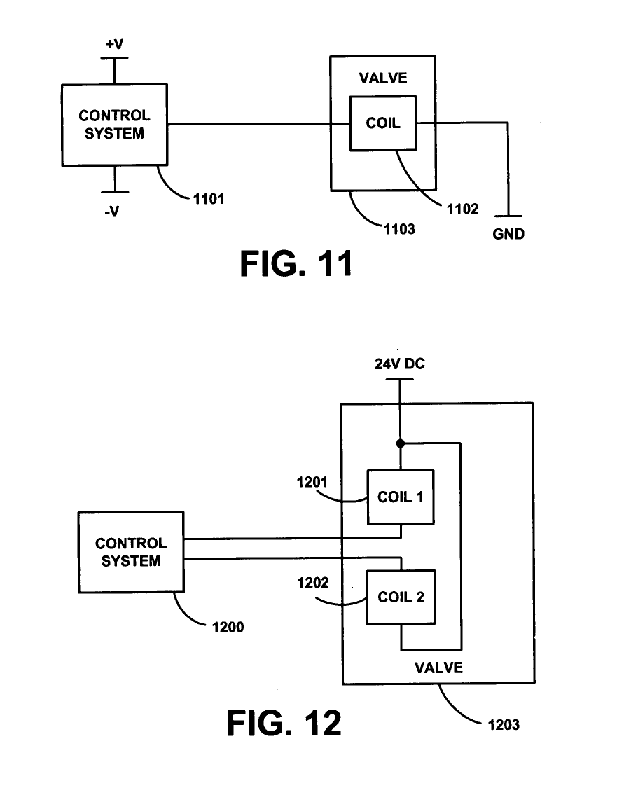

FIG. 11 depicts an alternative embodiment for a control system wherein a coil 1102 of a valve 1103 is tied to ground at one end. The control system 1101 switches the other end of the coil 1102 to +V and −V to generate bipolar actuation. This may also have one end of the coil 1102 tied to +12V, and the control system 1101 switches from +24V to GND.

FIG. 12 depicts an alternative embodiment for a control system of a valve 1203 with two coils 1201, 1202. One is wound opposite the first. The polarity of the current (and voltage) is the same for both coils 1201, 1202. However, because the winding direction of one coil is opposite the other, the coils 1201, 1202 generate two oppositely opposed magnetic fields. The valve 1203 is thus magnetically bipolar. The schematic is shown as 24V tied to the coils 1201, 1202, and the control system 1200 switching to ground.

The present method and apparatus may be incorporated in a many other applications than just those depicted in this disclosure.

The steps or operations described herein are just some examples of the present method and apparatus. There may be many variations to these steps or operations without departing from the spirit of the invention. For instance, the steps may be performed in a differing order, or steps may be added, deleted, or modified.

Although embodiments of the present method and apparatus have been depicted and described in detail herein, it will be apparent to those skilled in the relevant art that various modifications, additions, substitutions, and the like can be made without departing from the spirit of the invention and these are therefore considered to be within the scope of the invention as defined in the following claims.

We claim:

1. An apparatus, comprising:
at least one spraybar assembly having a plurality of spray valves;
a controller that outputs respective predetermined control signals of a plurality of control signals for the plurality of spray valves in the spraybar assembly; and
each control signal of the plurality of control signals having a series of positive and negative pulses.

2. The apparatus according to claim 1, wherein each control signal of the plurality of control signals has a series of positive pulses interleaved with a series of negative pulses.

3. The apparatus according to claim 1, wherein each control signal of the plurality of control signals has at least one positive pulse followed by at least one negative pulse.

4. The apparatus according to claim 1, wherein each negative pulse is a mirror image of each positive pulse.

5. The apparatus according to claim 1, wherein the controller has a plurality of ports respectively for the plurality of control signals, and wherein each control signal is formed of a series of positive and negative pulses, at least one of the control signals being different in terms of at least one of pulse shape, pulse duration, and pulse frequency from the other control signals.

6. The apparatus according to claim 1, wherein each valve in the spraybar assembly has a coil which is energized by a respective control signal, and wherein residual magnetism is substantially minimized in the coil and valve by the occurrence of positive and negative pulses.

7. The apparatus according to claim 1, wherein the positive and negative pulses are substantially mirror images of one another.

8. The apparatus according to claim 1, wherein the control signal is formed of a groups of positive pulses that alternate with groups of negative pulses such that residual magnetism is substantially eliminated in the valves.

9. An apparatus, comprising:
a printing unit having a plurality of spraybar assemblies;
each of the spraybar assemblies having a respective plurality of spray valves;
a controller that outputs respective predetermined control signals of a plurality of control signals for the plurality of spray valves in each of the spraybar assembly; and
each control signal of the plurality of control signals having a series of positive and negative pulses;
wherein residual magnetism is substantially minimized in the spray valves by the occurrence of positive and negative pulses.

10. The apparatus according to claim 9, wherein each control signal of the plurality of control signals has a series of positive pulses interleaved with a series of negative pulses.

11. The apparatus according to claim 9, wherein each control signal of the plurality of control signals has at least one positive pulse followed by at least one negative pulse.

12. The apparatus according to claim 9, wherein each negative pulse is a mirror image of each positive pulse.

13. The apparatus according to claim 9, wherein the controller has a plurality of ports respectively for the plurality of control signals, and wherein each control signal is formed of a series of positive and negative pulses, at least one of the control signals being different in terms of at least one of pulse shape, pulse duration, and pulse frequency from the other control signals.

14. The apparatus according to claim 9, wherein each valve in the spraybar assembly has a coil which is energized by a respective control signal, and wherein residual magnetism is substantially minimized in the coil and valve by the occurrence of positive and negative pulses.

15. The apparatus according to claim 9, wherein the positive and negative pulses are substantially mirror images of one another.

16. The apparatus according to claim 9, wherein the control signal is formed of a groups of positive pulses that alternate with groups of negative pulses such that residual magnetism is substantially eliminated in the valves.

17. A method, comprising:
providing at least one spraybar assembly in a printing unit, the spraybar assembly having a plurality of spray valves;
outputting respective predetermined control signals of a plurality of control signals for the plurality of spray valves in the at least one spraybar assembly; and
forming each control signal of the plurality of control signals with a series of positive and negative pulses that substantially minimizes residual magnetism in the spray valves by the occurrence of positive and negative pulses.

18. The method according to claim 17, wherein each control signal of the plurality of control signals has a series of positive pulses interleaved with a series of negative pulses, and wherein each negative pulse is a mirror image of each positive pulse.

19. The method according to claim 17, wherein the controller has a plurality of ports respectively for the plurality of control signals, and wherein each control signal is formed of a series of positive and negative pulses, at least one of the control signals being different in terms of at least one of pulse shape, pulse duration, and pulse frequency from the other control signals.

20. The method according to claim 17, wherein the control signal is formed of a groups of positive pulses that alternate with groups of negative pulses such that residual magnetism is substantially eliminated in the valves.
